(19) United States
(12) Patent Application Publication
(10) Pub. No.: US 2009/0202045 A1
(43) Pub. Date: Aug. 13, 2009

(54) TREATMENT BOOTH FOR RADIATION THERAPY

(75) Inventors: Timothy E. Guertin, Saratoga, CA (US); Marcel R. Marc, San Jose, CA (US)

Correspondence Address: HOUST CONSULTING (Varian), P.O.BOX 2688, SARATOGA, CA, 95070-0688, US

(73) Assignee: Varian Medical Systems Technologies, Inc.

(21) Appl. No.: 12/030,171

(22) Filed: Feb. 12, 2008

(51) Int. Cl. H05G 1/04; G21K 1/00

(52) U.S. Cl. 378/195; 378/197

(57) ABSTRACT

A radiation system includes a frame having a housing, a radiation source disposed in the housing of the frame, and a supporting device. The frame is curve-shaped and rotatably supported on a floor partially enclosing a space. The supporting device is disposed in the space and movable. The supporting device is adapted to support a patient in a generally seated position. A radiation method is also provided.

### TECHNICAL FIELD

This invention relates in general to medical imaging and treatment and in particular to radiation systems and methods useful in diagnosis and treatment of tumors.

### BACKGROUND

Various radiation systems and methods have been known for diagnostic imaging and radiation therapy. A goal of radiation therapy is to deliver high dose radiation to the tumorous tissue while minimizing dose to the surrounding healthy tissue and sparing adjacent critical organs. To achieve this goal, various techniques have been developed including particle therapy, intensity-modulated radiation therapy (IMRT), and image-guided radiation therapy (IGRT).

In particle therapy, charged particles such as protons or carbon ions are used as the source of radiation. Due to the “Bragg peak” effect, the charged particles are more concentrated around the area where the charged particles stop. Thus, by selecting the energy of charged particles, the particles stop at a precise location within the patient. As a result, the healthy tissue distal to the radiation source with respect to the tumor receives no radiation, and the intensity of charged particles to the healthy tissue that is proximate to the radiation source is significantly reduced.

In intensity-modulated radiation therapy, the radiation dose is designed to conform to the size, shape, and location of the tumor by modulating or controlling the intensity of the radiation beam using a multi-leaf collimator. Treatment is planned by using computed tomography (CT) images in conjunction with computerized dose calculations to determine the dose intensity pattern that best conforms to the tumor size and shape.

Image-guided radiation therapy uses imaging technology to guide radiation therapy process. Various factors can cause a tumor to move including inter- and intra-fraction motion of the patient in treatment. Image-guided radiation therapy allows adjustment of the radiation beam based on the actual location of the tumor while the patient is in the treatment position.

In existing IMRT or IGRT systems, the patient is generally supported on a couch or tabletop in a lying position. A gantry containing a radiation source rotates around the patient to project a radiation beam onto a target. In such systems, the patient may feel uncomfortable when the radiation source is rotating close to the patient. In the case where the radiation source is secured to an arm such as C-arm, the patient may be injured if it accidentally comes in contact with the rotating arm.

Existing radiation systems are also bulky and generally occupy large space. This is partly contributed to the configuration of the existing systems with large rotating gantry and couch for supporting patients in lying positions. In a proton radiation system, an electromagnetic system is typically used to control the trajectory of the proton beam. Such electromagnetic system generally takes up a lot of space.

Therefore, it is desirable to provide a radiation method and system that is compact, space efficient, and approachable to the patients.

### SUMMARY

A radiation system is provided comprising a frame having a housing, a radiation source disposed in the housing of the frame, and a supporting device. The frame is curve-shaped and rotatably supported on a floor partially enclosing a space. The supporting device is disposed in the space and movable. The supporting device is adapted to support a patient in a generally seated position.

In some embodiments, the supporting device is translationally movable. In some embodiments, the supporting device is rotatable. In a preferred embodiment, the supporting device is rotatable and translationally movable concurrently.

In some embodiments, the frame is rotatable about a horizontal axis. In a preferred embodiment, the radiation source is an X-ray radiation source. In some embodiments, the radiation source is configured to generate X-ray beams at mega-volt energy levels.

In some embodiments, the radiation system further includes a beam adjuster that is configured to adjust a parameter of a radiation beam generated from the radiation source. The parameter can be the intensity, energy, size, and shape of the radiation beam. In some embodiments, the radiation system further includes a second radiation source and a second detector disposed opposite to the second radiation source. The second radiation source is configured to generate X-ray beams at kilo-volt energy levels.

In a preferred embodiment, the frame is generally U-shaped.

In one aspect, a method of irradiating a target in a subject is provided. The method comprises the steps of positioning a subject on a supporting device at a first position, positioning a radiation source to deliver a radiation beam to a target in the subject at the first position, moving the supporting device to position the subject at a second position, and concurrently moving the radiation source synchronically with the moving of the supporting device to deliver the radiation beam to the target while the patient is being moved from the first to the second position. In some embodiments, a parameter of the radiation beam is adjusted while the radiation source is being moved concurrently with the supporting device. The parameter can be the intensity, energy, size, and shape of the radiation beam.

In another provided method, a patient is positioned on a supporting device at a generally seated first position. The supporting device is then moved to position the patient at a generally seated second position. A radiation beam is concurrently delivered to a target in the patient while the patient is being moved from the first position to the second position. A parameter of the radiation beam changes synchronically with the moving of the patient from the first position to the second position. The parameter can be the intensity, energy, size, and shape of the second radiation beam. The supporting device can be rotated, or translated up or down. Preferably, the supporting device can be rotated and translated up or down concurrently.

In a further provided method, a patient is positioned on a supporting device at a generally seated first position. A first radiation beam is delivered to a target in the patient at the first position. The first radiation beam is formed from a cone radiation beam which can be adjusted or collimated as to the intensity, energy, size, and shape of the beam. The supporting device is then moved to position the patient at a generally seated second position. A second radiation beam is delivered to the target at the second position. The second radiation beam is formed from a cone radiation beam which can be adjusted or collimated as to the intensity, energy, size, and shape of the cone radiation beam.

### BRIEF DESCRIPTION OF THE DRAWINGS

These and various other features and advantages of the present invention will become better understood upon reading of the following detailed description in conjunction with the accompanying drawings and the appended claims provided below, where:

FIG. 1 is a functional diagram illustrating a radiation system in accordance with one embodiment of the invention;

FIG. 2 illustrates a treatment booth in accordance with one embodiment of the invention;

FIG. 3 illustrates a treatment booth in accordance with another embodiment of the invention;

FIG. 4 illustrates a treatment booth in accordance with another embodiment of the invention;

FIG. 5 is a flow chart illustrating a radiation method in accordance with one embodiment of the invention;

FIG. 6 is a flow chart illustrating a radiation method in accordance with another embodiment of the invention; and

FIG. 7 is a flow chart illustrating a radiation method in accordance with further embodiment of the invention.

### DETAILED DESCRIPTION OF VARIOUS EMBODIMENTS

Various embodiments of the present invention are described hereinafter with reference to the figures. It should be noted that the figures are not drawn to scale and elements of similar structures or functions are represented by like reference numerals throughout the figures. It should also be noted that the figures are only intended to facilitate the description of specific embodiments of the invention. They are not intended as an exhaustive description of the invention or as a limitation on the scope of the invention. In addition, an aspect described in conjunction with a particular embodiment of the present invention is not necessarily limited to that embodiment and can be practiced in any other embodiments of the present invention. It will be appreciated that while various embodiments of the invention are described in connection with radiation treatment of tumors, the claimed invention has applications in other industries such as the security industry.

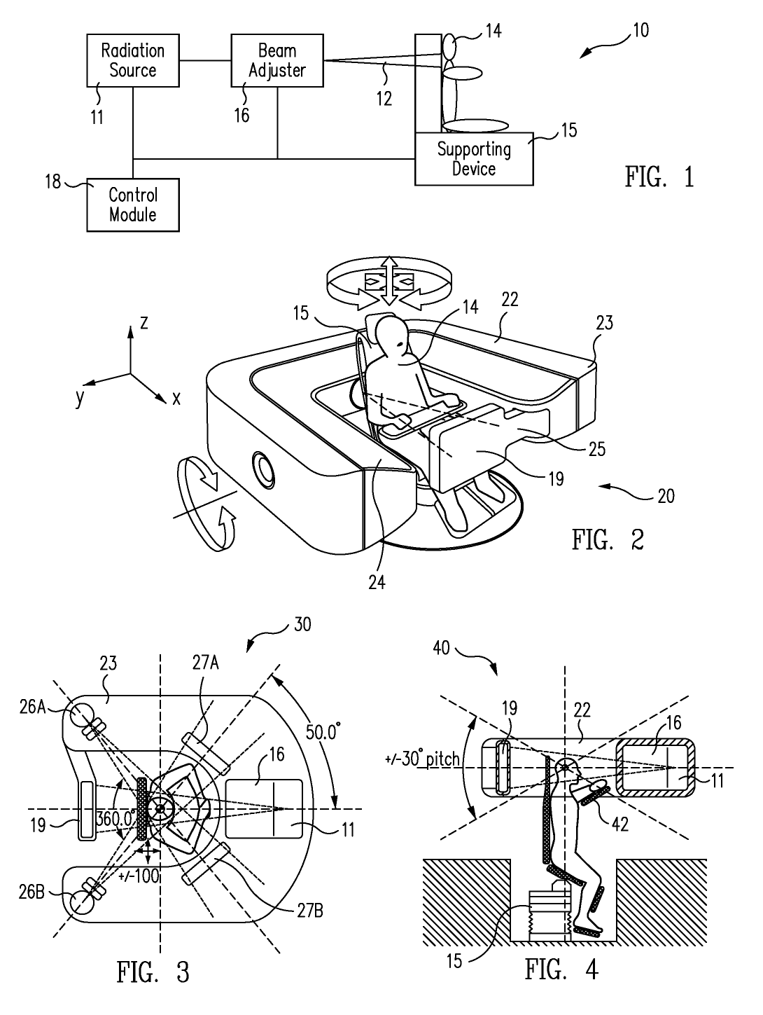

FIG. 1 is a functional diagram illustrating a radiation system 10 in accordance with some embodiments of the invention. The radiation system 10 includes a radiation source 11. The radiation source 11 generates a radiation beam 12 toward a subject 14 such as a patient positioned on a supporting device 15. A beam adjuster 16 is located between the radiation source 11 and supporting device 15 and functions to adjust the shape, size, direction, and/or intensity of a radiation beam reaching the patient 15. The radiation system 10 also includes a control module 18 coupled to the radiation source 11, supporting device 15, and beam adjuster 16 to control their operations. A portal image device 19 (FIG. 2-4) may be disposed opposite to the radiation source 11. In some embodiments, the radiation source 11 is configured to generate a radiation beam suitable for therapeutic treatment of diseases such as tumor. In such cases, the radiation system 10 may optionally include one or more image beam sources 26A, 26B, and one or more image detectors 27A, 27B coupled to the control module 18 (FIG. 3).

The radiation source 11 can be any beam-generating source depending on the nature of treatment or application. By way of example, the radiation source 11 may be a source that generates X-ray beams, proton beams, heavy ion beams such as carbon ion beams, beta ray beams, positron beams, antiproton beams, neutron beams, alpha ray beams etc. For example, in some embodiments, the radiation source 11 generates X-ray beams at a mega-volt (MV) energy spectrum suitable for therapeutic treatment of tumor, and the portal image device 19 is a detector configured to detect X-ray beams that penetrate the patient 14. In some embodiments, the radiation source 11 generates protons and the device 19 functions as an image device configured to detect protons that penetrate the patient. In a preferred embodiment, the radiation source 11 generates a radiation beam 12 in cone shape. Various radiation sources are known to those skilled in the art.

The beam adjuster 16 may include a multi-leaf collimator. Multi-leaf collimators are known to those skilled in the art and therefore they are not described in great detail in order to simplify the description of the invention. In general, a multi-leaf collimator includes a plurality of pairs of opposing veins or leaves made of materials that effectively block the radiation generated by the radiation source. Each pair of the leaves is controllably movable relative to each other. By driving each leaf into different positions, various sizes and shapes of the radiation beam can be formed and the intensity of the radiation beam can be modulated.

The number of leaves in a multi-leaf collimator can have a wide range. Generally, a multi-leaf collimator having a large number of narrow leaves has a higher resolution than a multi-leaf collimator having a small number of thick leaves. A high resolution is generally beneficial in shaping the radiation beam precisely to the shape of the tumor and modulating the radiation intensity precisely.

In some embodiments, the beam adjuster may include more than one multiple leaf collimators, with one collimator superimposed over another collimator. The multiple leaves in one collimator are at an angle, e.g., 45 or 90 degrees with respect to the multiple leaves in another collimator. Such an arrangement of more than one multi-leaf collimator superimposed over each other allows shaping of the radiation beam in more diverse shapes.

The supporting device 15 is configured to support a patient in a generally seated position. By way of example, the supporting device 15 can be in the form of a chair. The supporting device 15 includes mechanisms that enable both translational and rotational motions of the supporting device 15. The mechanisms for providing translational and/or rotational motion are well known to those skilled in the art and therefore they are not described in great detail in order to simplify the description of the invention. In general, any mechanisms may be used to provide translational or rotational motion including bearings, rollers, actuators, and motors, etc.

The control module 18 includes a signal processor such as, for example, a digital signal processor (DSL), a central processing unit (CPU), or a microprocessor (μP), and a memory coupled to the signal processor. The memory serves to store a treatment plan for the patient and other programs for the operation of the radiation system 10. The signal processor executes the programs and generates signals for the operation of the radiation source 11, supporting device 15, beam adjuster 16, portal image device 19, image beam source 26A, 26B, and image detector 27A, 27B etc. The signal processor also receives signals from supporting device 15 and patient 14 and generates tracking signals in response thereto.

FIG. 2 illustrates a radiation system or treatment booth 20 in accordance with one embodiment of the invention. The treatment booth 20 includes a frame 22 generally in a curved shape. By way of example, the frame 22 can be U-shaped or C-shaped, or in any semi-enclosed configuration. The frame 22 generally lies in a plane. The frame 22 may be rotatably supported on the floor in a treatment room by one or more support structures (not shown). For example, the frame 22 may be rotatable about a horizontal axis (y-axis, pitch-rotation) in, e.g., ±30 degrees.

The frame 22 provides a housing for a radiation source 11 and a beam adjustor 16 (FIGS. 3-4). The frame 22 has a curved body with a first end portion 23 and a second end portion 24. The frame 22, supported on a floor in a treatment room, partially encloses a space in which a supporting device 15 can be disposed for positioning a patient 14. The first and second end portions 23, 24 partially define an access into and out of the space.

The supporting device 15 is configured to support or position a patient 14 in a generally seated position. The supporting device 15 is capable of translational and/or rotational motion. For example, the supporting device 15 is movable in a longitudinal direction (x-direction) to position the patient closer to or far away from the radiation source 11. The supporting device 15 is also movable in a lateral direction (y-direction) to align or position the patient in the radiation field 12. The supporting device 15 is also movable in a vertical direction (z-direction) via a lifting mechanism to move the patient 14 up or down with respect to the radiation source 11. The motions of the supporting device 15 in three translational degrees of freedom allows a wide range of positions of the patient in the radiation system and thus maximizes the use of the radiation field.

In some embodiments, the supporting device 15 is rotatable about a vertical axis. For example, the supporting device is rotatable about the z-axis (yaw-rotation) in 360 degrees so that a target in the patient 14 may be exposed to a fixed radiation beam at varying angles. In some embodiments, the supporting device 15 is further rotatable about the x-axis (roll-rotation) and y-axis (pitch-rotation).

In some embodiments, the supporting device 15 is capable of motion in three translational degrees of freedom, and three rotational degrees of freedom.

In a preferred embodiment, the supporting device 15 is rotatable about a vertical axis, and concurrently, movable in translational degrees. The combination of rotation and translation such as about a vertical axis (z-axis) and in a vertical direction (z-direction) allows the patient 14 to be moved up or down while being rotated, thus exposing a target in the patient 14 to a radiation beam in a helical pattern.

In some embodiments, the supporting device 15 is capable of translational and/or rotational motion, and concurrently, the frame 22 is rotatable about a horizontal axis such as y-axis. The motions of the supporting device 15 and the frame 22 can be controlled or coordinated by the control module 18 so that the supporting device 15 and the frame 22 are concurrently moved in a synchronic manner. The combination of concurrent motions of the supporting device 15 and the frame 22 allows more efficient use of space, and allows more angles of the radiation to a target, thus providing more possibilities of conformal delivery of radiation, and sparing critical organs in radiation therapy.

The supporting device 15 can be coupled to the control module 18 by a wired or wireless link, or by any other suitable means. By way of example, various sensors (not shown) such as optical and electrical sensors can be installed in the supporting device 15 to provide communication with the control module 18. The communication between the supporting device 15 and the control module 18 allows the supporting device 15 to receive signals from the control module 18 for pre-determined motions, and allows the control module 18 to receive signals from the supporting device 15 for position feedback and other status information.

A portal image device 19 may be coupled to the first end portion 23 of the frame 22. The portal image device 19 can be supported by an articulated arm 25 that is rotatable about each of the three axes (x, y, z). Depending on the nature of the applications, the portal image device 19 can be an image detector.

FIG. 3 illustrates a treatment booth 30 in accordance with another embodiment of the invention. Like the embodiment illustrated in FIG. 2, the treatment booth 30 illustrated in FIG. 3 includes a curve-shaped frame that may be rotatably supported on the floor in a treatment room. The frame 22 includes a housing for a radiation source 11 and a beam adjustor 16. The frame 22 partially encloses a space in which a supporting device 15 is disposed for supporting or positioning a patient 14 in a generally seated position. The first and second end portions 23, 24 partially define an access into and out of the space. Like the embodiment illustrated in FIG. 2, the supporting device 15 is capable of both translational and rotational motions (x, y, z). In comparison with the embodiment illustrated in FIG. 2, the treatment booth 30 illustrated in FIG. 3 further includes one or more imaging beam sources 26A, 26B disposed in the first and/or second end portions 23, 24, and one and more imaging detectors 27A, 27B opposite to corresponding imaging beam sources. Alternatively, the one or more image beam sources are not disposed in the frame, but supported for example on the ceiling or floor of a treatment room. The imaging source 26A, 26B and imaging detectors 27A, 27B may have the capabilities of performing computed tomography (CT) or cone beam CT (CBCT), or tomosynthesis. The configuration illustrated in FIG. 3 can provide an image-guided radiation therapy to allow adjustment of the radiation beam based on the actual location of the target while the patient is in the treatment position.

FIG. 4 illustrates a treatment booth 40 in accordance with another embodiment of the invention. Like the embodiments illustrated in FIGS. 2 and 3, the treatment booth 40 illustrated in FIG. 4 includes a curved frame 22 that can be rotatably supported on the floor in a treatment room. The curved frame 22 includes a housing for a radiation source 11 and a beam adjustor 16. The curved frame 22 is rotatable about a horizontal axis such as y-axis up to e.g., ±30 degrees. Like the embodiments illustrated in FIGS. 2 and 3, the supporting device 15 is capable of both translational and rotational motions. In comparison, the supporting device 15 in the treatment booth 40 illustrated in FIG. 4 is disposed in a recess in the floor. Various restraining means 40 are shown in FIG. 4. The configuration illustrated in FIG. 4 renders the radiation system more space efficient.

In operation, the patient 14 is positioned on the supporting device 15 and immobilized by suitable restraining devices as needed. For example, the patient 14 can be supported on the supporting device 15 in a generally seated position. The supporting device 15 moves as directed by the control module 18, in translational and/or rotational degrees of freedom, to position the patient 14 at a predetermined position based on a treatment plan established for the patient. Once the patient 14 is at the predetermined position, the radiation source 11 and the beam adjuster 16 are activated by the control module 18 to deliver a radiation beam to a target based on the treatment plan.

The treatment plan for the patient is established based on the nature, size, shape, and location of the target in the patient. The treatment plan includes data of the location and orientation of the target with respect to the coordinates of the radiation system established in a pre-treatment session. The treatment plan preferably includes data regarding the radiation doses different portions of the target should receive. Typically, the treatment plan sets forth several treatment sessions, and includes data regarding the shape of the radiation beam and the time duration the radiation beam should be applied to the target at several fields during a treatment session. By applying radiation at several fields, with the shape of the beam optimized to account for the cross sectional shape of the target and other anatomical factors, a conformal dose is delivered.

When a patient is treated in an intensity-modulated radiation therapy (IMRT), the treatment plan includes data regarding the motions of the leaves of the multi-leaf collimator for each field in the treatment session to achieve intensity-modulated radiation therapy. When each field is being executed, the multiple leaves in MLC beam adjuster move according to the IMRT plan so that different portions of the tumor's cross-section receive different amounts of radiation. For example, if one part of the tumor is close to a critical or sensitive structure, the leaves in the MLC beam adjuster may block the radiation near that part during some portion of the field, thereby decreasing the radiation dose received by that part of the tumor and minimizing the possible adverse effect of the radiation exposure by the critical or sensitive structure. In intensity-modulated proton therapy (IMPT), the treatment plan may include data regarding proton beam scanning, or motions of MLC leaves for each field in the treatment session to achieve intensity-modulated proton therapy.

The treatment plan may also include reference data regarding the position of the target, and the relationship between the target movement and the patient's inter- or intra-fraction movement established during a pre-treatment session for image-guided radiation therapy (IGRT). The reference data or the relationship data can be obtained by any suitable imaging techniques such as planar radiography, ultrasound (US), computed tomography (CT), single photon emission computed tomography (SPECT), magnetic resonance imaging (MRI), magnetic resonance spectroscopy (MRS), positron emission tomography (PET), etc. In image-guided radiation therapy, the control module receives data from one or more planar or volumetric imaging devices representing near real time images of the target. The near real time image data are compared with the reference data obtained in the pre-treatment session. The results can then be used to position the patient and/or the radiation source during the treatment session. U.S. Pat. No. 7,227,925 describes a method and system for image-guided radiation therapy, the disclosure of which is incorporated herein by reference in its entirety.

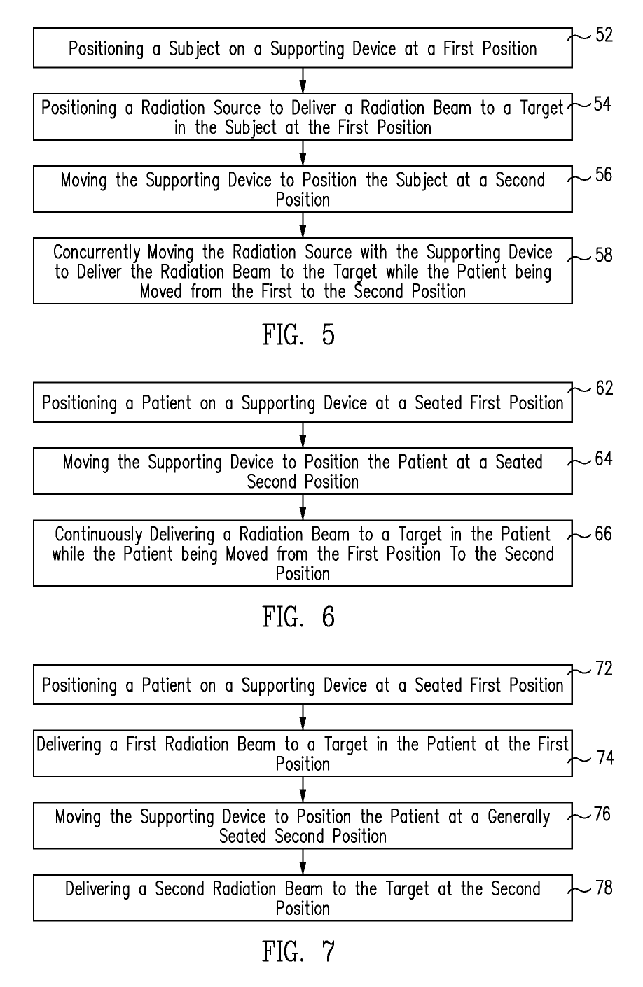

FIG. 5 is a flow chart illustrating a radiation method in accordance with one embodiment of the invention. By way of example, the method can be implemented using the treatment booth or radiation system as illustrated in FIGS. 1-4 described above. Other suitable radiation systems may also be used to perform the methods described herein and hereafter.

At step 52, a subject is positioned on a supporting device at a first position. For example, a patient can be positioned on a supporting device in a generally seated first position. Preferably the supporting device is movable in three translational and three rotational degrees of freedom.

At step 54, a radiation source is positioned to align the radiation source with a target such as a tumor in the patient at the first position. By way of example, the radiation source can be housed and secured in a frame or gantry, and the positioning of the radiation source can be performed by moving the frame or gantry. The motion of the frame and positioning of the radiation source can be controlled by a control module. The radiation source is then turned on and a radiation beam is delivered to the target in the subject at the first position. The radiation beam can be adjusted or modulated by a beam adjuster such as a multi-leaf collimator. By way of example, the intensity, energy, size, and/or shape of the radiation beam can be adjusted or collimated to conform the size, shape, and location of the tumor in the patient.

At step 56, the supporting device is moved to position the subject at a second position. For example, the supporting device can be rotated about a vertical axis up to 360 degrees such that a patient can be positioned at a second position facing any directions with respect to its first position. Alternatively, the supporting device can be moved up or down in a vertical direction. In some embodiments, the supporting device is rotated and moved up or down concurrently such that the patient is moved in a helical pattern.

At step 58, the radiation source is concurrently moved with the motion of the supporting device, as can be coordinated by a control module. The radiation beam is delivered to the target while the radiation source is moved e.g. synchronically with the patient from the first position to the second position. The intensity, energy, size, and/or shape of the radiation beam can be modulated or adjusted to conform to the tumor's size, shape, and location as the patient is moving. The synchronic motion of the radiation source and the supporting device is advantageous in delivering a radiation beam to a tumor in a patient at an optimal angle to minimize or avoid radiation to critical organs adjacent to the tumor.

FIG. 6 is a flow chart illustrating a radiation method in accordance with another embodiment of the invention.

At step 62, a patient is positioned on a supporting device at a generally seated first position.

At step 64, the supporting device is moved to position the patient at a generally seated second position. For example, the supporting device can be rotated about a vertical axis in 360 degrees such that a patient can be positioned at a second position facing any directions with respect to its first position. Alternatively, the supporting device can be moved up or down in a vertical direction. In some embodiments, the supporting device is rotated and moved up or down concurrently such that the patient is moved in a helical pattern.

At step 66, concurrently with the motion of the patient from the first position to the second position, a radiation beam is continuously delivered to the target. One advantage of the embodiment is that the radiation source can be fixed at a location and delivers a continuous radiation beam while the patient is moving. The radiation source can be a charged particle source or X-ray source that is configured to generate a cone radiation beam. The intensity, energy, size, and/or shape of the radiation beam can be modulated or adjusted to conform to the tumor's size, shape, and location as the patient is moving.

FIG. 7 is a flow chart illustrating a radiation method in accordance with a further embodiment of the invention.

At step 72, a patient is positioned on a supporting device at a generally seated first position.

At step 74, a first radiation beam is delivered to a target in the patient at the first position. The intensity, energy, size, and/or shape of the first radiation beam can be adjusted to conform to the size, shape, and location of the target in the patient at the first position. By way of example, the radiation beam can be a cone radiation beam.

At step 76, the supporting device is moved to position the patient at a generally seated second position.

At step 78, a second radiation beam is delivered to a target in the patient at the second position. The intensity, energy, size, and/or shape of the second radiation beam can be adjusted to conform to the size, shape, and location of the target in the patient at the second position. By way of example, the radiation beam can be a cone shaped radiation beam.

From the foregoing it will be appreciated that, although specific embodiments of the invention have been described herein for purposes of illustration, various modifications may be made without deviating from the spirit and scope of the invention. For instance, a gating process may be incorporated in the process of irradiation. For example, the control module may generate a signal to momentarily shut down the radiation source in response to sudden movement of the patient in an abnormal pattern, such as coughing, sneezing, muscle cramping etc. When the tumor resumes its normal movement, e.g., the periodic movement associated with the breathing of the patient, the control module may turn the radiation source back on, permitting the radiation on the patient. In addition, one or more marker may be coupled to the patient to track the motion of the tumor under radiation treatment. One or more markers may also be placed on the supporting device to track the motion of the supporting device. A video camera may be used to detect the images of the marker and generate position signals of the markers or the supporting device. The marker can be any suitable materials that are substantially opaque to an image beam thereby forming a sharp image on an image detector. All these or other variations and modifications are contemplated by the inventors and within the scope of the invention.

What is claimed is:

1. A radiation system comprising:
a frame having a housing, said frame being curve-shaped and rotatably supported on a floor partially enclosing a space;
a radiation source disposed in the housing of the frame; and
a supporting device disposed in the space, said supporting device being movable and adapted to support a patient in a generally seated position.

2. The radiation system of claim 1 wherein said supporting device is translationally movable.

3. The radiation system of claim 1 wherein said supporting device is rotatable.

4. The radiation system of claim 1 wherein said supporting device is rotatable and translationally movable concurrently.

5. The radiation system of claim 1 wherein said frame is rotatable about a horizontal axis.

6. The radiation system of claim 1 further comprising a detector disposed opposite to the radiation source.

7. The radiation system of claim 1 wherein said radiation source is an X-ray radiation source.

8. The radiation system of claim 1 wherein said radiation source is an X-ray radiation source configured to generate X-ray beams at mega-volt energy levels.

9. The radiation system of claim 1 wherein said radiation source is a particle radiation source configured to generate charged particle beams at mega-volt energy levels.

10. The radiation system of claim 1 further comprising a beam adjuster that is configured to adjust a parameter of a radiation beam generated from the radiation source, said parameter comprising the intensity, energy, size, and shape of the radiation beam.

11. The radiation system of claim 1 further comprising a second radiation source and a second detector disposed opposite to the second radiation source, said second radiation source being configured to generate X-ray beams at kilo-volt energy levels.

12. The radiation system of claim 1 wherein said frame is generally U-shaped.

13. A method of irradiating a target in a subject, comprising the steps of:
positioning a subject on a supporting device at a first position;
positioning a radiation source to deliver a radiation beam to a target in the subject at the first position;
moving the supporting device to position the subject at a second position; and
concurrently moving the radiation source with the moving of the supporting device to deliver the radiation beam to the target while the patient being moved from the first to the second position.

14. The method of claim 13 wherein a parameter of the radiation beam is adjusted while the radiation source being moved concurrently with the supporting device, said parameter comprising the intensity, energy, size, and shape of the radiation beam.

15. The method of claim 13 wherein the step of positioning a subject comprises positioning a patient on the supporting device at a generally seated first position, and the step of moving the supporting device comprises moving the supporting device to position the patient at a generally seated second position.

16. The method of claim 13 wherein the step of moving the supporting device comprises rotating the supporting device on which a patient is supported in a generally seated position.

17. The method of claim 13 wherein the step of moving the supporting device comprises moving up or down the supporting device on which a patient is supported in a generally seated position.

18. The method of claim 13 wherein the step of moving the supporting device comprises concurrently rotating and moving up or down the supporting device on which a patient is supported in a generally seated position.

19. The method of claim 13 wherein said first and second radiation beams are X-ray beams at mega-volt energy levels.

20. A method of irradiating a target in a patient, comprising the steps of:
positioning a patient on a supporting device at a generally seated first position;
moving the supporting device to position the patient at a generally seated second position; and
continuously delivering a radiation beam to a target in the patient while the patient being moved from the first position to the second position, wherein a parameter of the radiation beam changes synchronically with the moving of the patient from the first position to the second position.

21. The method of claim 20 wherein said parameter comprises the intensity, energy, size, and shape of the second radiation beam.

22. The method of claim 20 wherein said radiation beam is an X-ray beam at a mega-volt energy level.

23. The method of claim 20 wherein said radiation beam is in cone shape.

24. The method of claim 20 wherein the step of moving comprises rotating the supporting device.

25. The method of claim 20 wherein the step of moving comprises moving the supporting device up or down.

26. The method of claim 20 wherein the step of moving comprises concurrently rotating and moving the supporting device up or down.

27. A method of irradiating a target in a patient, comprising the steps of:
positioning a patient on a supporting device at a generally seated first position;
delivering a first radiation beam to a target in the patient at the first position, said first radiation beam being formed from a cone radiation beam a parameter of which being adjusted, said parameter comprising the intensity, energy, size, and shape of the cone radiation beam;
moving the supporting device to position the patient at a generally seated second position; and
delivering a second radiation beam to the target at the second position, said second radiation beam being formed from a cone radiation beam a parameter of which being adjusted, said parameter comprising the intensity, energy, size, and shape of the cone radiation beam.

28. The method of claim 27 wherein said first and second radiation beams are X-ray beams at mega-volt energy levels.

29. The method of claim 27 wherein said first and second radiation beams are generated from a radiation source that is movable.

30. The method of claim 27 wherein the step of moving the supporting device comprises rotating the supporting device.

31. The method of claim 27 wherein the step of moving the supporting device comprises moving up or down the supporting device.

32. The method of claim 27 wherein the step of moving the supporting device comprises concurrently rotating and moving up or down the supporting device.

33. The method of claim 27 wherein the step of positioning a patient comprises positioning the patient in a radiation system which comprises:
a curve-shaped frame having a housing, said frame being rotatably supported on a floor partially enclosing a space;
a radiation source disposed in the housing providing the first and second radiation beams; and
the supporting device disposed in the space, said supporting device being movable and adapted to support a patient in a generally seated position.

34. The radiation system of claim 11 wherein the second radiation source and second detector are configured to carry out cone-beam computed tomography.
